(19) United States
(12) Patent Application Publication
(10) Pub. No.: US 2009/0094299 A1
(43) Pub. Date: Apr. 9, 2009

(54) Apparatus and method for defragmenting files on a hydrid hard disk

(75) Inventors: Jung-Hwan Kim, Seoul (KR); Seong-Jun Ahu, Seoul (KR); Young-Bong Kim, Seoul (KR); Young-II Seo, Gyeonggi-do (KR); Chan-Ho Park, Gyeonggi-do (KR)

Correspondence Address: MILLS & ONELLO LLP, ELEVEN BEACON STREET, SUITE 605, BOSTON, MA, 02108, US

(73) Assignee: Samsung Electronics Co., Ltd., Gyeonggi-do (KR)

(21) Appl. No.: 12/287,338

(22) Filed: Oct. 8, 2008

(30) Foreign Application Priority Data
Oct. 8, 2007 (KR) 10-2007-0100987

(51) Int. Cl. G06F 12/00; G06F 12/02

(52) U.S. Cl. 707/205; 707/200; 707/E17.01

(57) ABSTRACT

An apparatus and method for defragmenting files on a hybrid hard disk are provided. The apparatus includes a nonvolatile memory located within the hybrid hard disk, a loading unit reading data of a fragmented cluster and temporarily storing the read data in the nonvolatile memory, and a writing unit writing the temporarily stored data in contiguous clusters.

### CROSS REFERENCE TO RELATED APPLICATION

This application claims priority from Korean Patent Application No. 10-2007-0100987 filed on Oct. 8, 2007, in the Korean Intellectual Property Office, the contents of which are incorporated herein by reference in their entirety.

### BACKGROUND OF THE INVENTION

1. Field of the Invention

The present invention relates to an apparatus and method for defragmenting files on a hybrid hard disk, and, more particularly, to an apparatus and method for defragmenting files on a hybrid hard disk that can provide improved defragmentation performance using a nonvolatile memory embedded in the hybrid hard disk without changing the structure of the hybrid disk.

2. Description of the Related Art

On a hard disk, a cluster is the smallest unit of disk space that the operating system can address and is the smallest amount of space that can be allocated to hold a file. On a standard hard disk formatted using the NT File System (NTFS) of Microsoft Windows, the maximum cluster size is 4 KB or 4,096 bytes.

Each time a new file is copied to a hard disk, an old file is deleted from the hard disk, and new information is added to existing files, files on the hard disk are likely to become more fragmented.

For example, if a file is copied to a hard disk, the operating system attempts to place the file into a first cluster available on the hard disk. If a file is larger than that the size of the first cluster, the operating system will put the rest of the file in the next available cluster (“second cluster”). If the second cluster is not located contiguous to the first cluster, the file becomes fragmented.

Fragmentation may also occur when information is added to an existing file.

For example, if the file is larger than the original cluster (“first cluster”) containing the existing file, the operating system will put the rest of the file in the next available cluster (“second cluster”).

Similarly, the file becomes fragmented when the second cluster is not located contiguous to the first cluster.

Further, each time a file is deleted from a hard disk, non-contiguous available clusters are created, thereby increasing the possibility of file fragmentation, especially if the file being deleted is fragmented.

As the number of fragmented files increases, a read/write head in a hard disk takes longer to find a desired file and transfer it to a memory. As the read/write head moves a longer distance, it requires more time to access a file. Thus, hard disk performance is degraded.

Hard disk fragmentation may cause slow boot-up, unexpected crashes, and unexplainable lock-ups, thereby resulting in degradation in overall system performance. A severely fragmented hard disk may make the system unbootable.

To solve the fragmentation problem, various defragmentation approaches have been proposed, including readjusting the location of each cluster that makes up a file on a hard disk. However, an existing hard disk drive has poor read/write performance for small files in assigning file fragments to contiguous clusters and requires considerable time to do so.

### SUMMARY OF THE INVENTION

The present invention provides an apparatus and method for defragmenting files on a hybrid hard disk, which can provide improved defragmentation performance using a nonvolatile memory embedded in the hybrid hard disk without changing the structure of the hybrid hard disk.

According to an aspect of the present invention, there is provided a method for defragmenting files on a hybrid hard disk, the method including temporarily storing data of a fragmented cluster in a nonvolatile memory embedded within the hybrid hard disk, and writing the temporarily stored data to contiguous clusters.

In one embodiment, the method further comprises reading the data temporarily stored in the nonvolatile memory.

In one embodiment, in the writing of the temporarily stored data to contiguous clusters, the temporarily stored data is written at one time.

According to another aspect of the present invention, there is provided an apparatus for defragmenting files on a hybrid hard disk, the apparatus including a nonvolatile memory located within the hybrid hard disk, a loading unit reading data of a fragmented cluster and temporarily storing the read data in the nonvolatile memory, and a writing unit writing the temporarily stored data in contiguous clusters.

In one embodiment, the loading unit reads the data temporarily stored in the nonvolatile memory and transfers the data to the writing unit.

In one embodiment, the writing unit writes the temporarily stored data at one time.

### BRIEF DESCRIPTION OF THE DRAWINGS

The foregoing and other objects, features and advantages of the invention will be apparent from the more particular description of preferred aspects of the invention, as illustrated in the accompanying drawings in which like reference characters refer to the same parts throughout the different views. The drawings are not necessarily to scale, emphasis instead being placed upon illustrating the principles of the invention.

FIG. 1 illustrates a process of defragmenting a file on a typical hard disk.

FIG. 2 illustrates the process illustrated in FIG. 1 over time.

FIG. 3 is a block diagram of an apparatus for defragmenting a file on a hybrid hard disk according to an embodiment of the present invention.

FIG. 4 illustrates a process of defragmenting a file on a hybrid hard disk according to an embodiment of the present invention.

FIG. 5 illustrates the process illustrated in FIG. 4 over time.

### DETAILED DESCRIPTION OF PREFERRED EMBODIMENTS

The present invention will now be described more fully with reference to the accompanying drawings, in which an apparatus and method for defragmenting a file on a hybrid hard disk according to preferred embodiments of the invention are shown.

The present invention is described hereinafter with reference to flowchart illustrations of methods according to exemplary embodiments of the invention. It will be understood that each block of the flowchart illustrations, and combinations of blocks in the flowchart illustrations, can be implemented by computer program instructions.

These computer program instructions can be provided to a processor of a general purpose computer, special purpose computer, or other programmable data processing apparatus to create means for implementing the functions specified in the flowchart block or blocks. These computer program instructions may also be stored in a computer usable or computer-readable memory that can direct a computer or other programmable data processing apparatus to function in a particular manner, such that the instructions implement the function specified in the flowchart block or blocks.

The computer program instructions may also be loaded into a computer or other programmable data processing apparatus to cause a series of operational steps to be performed on the computer or other programmable apparatus to produce a computer implemented process for implementing the functions specified in the flowchart block or blocks.

In addition, each block may represent a module, a segment, or a portion of code, which may comprise one or more executable instructions for implementing the specified logical functions.

It should also be noted that in other implementations, the functions noted in the blocks may occur out of the order noted or in different configurations of hardware and software. For example, two blocks shown in succession may, in fact, be executed substantially concurrently, or the blocks may sometimes be executed in reverse order, depending on the functionality involved.

A typical defragmentation process gathers all fragments that constitute a file and rearranges the order in which the fragments are stored by placing them in contiguous clusters that start at the beginning of a hard disk. In this case, all available clusters are moved toward the end of the hard disk.

If a single file is broken up into multiple fragments and stored as such, a defrag program reads clusters with fragmented files, temporarily stores them in a DRAM on a host or in a cluster available on a disk, and writes the stored files to contiguous clusters.

The above defragmentation process is repeated for clusters with fragmented files so that the fragmented files can be stored in clusters that are contiguous on the disk.

If a hard disk to be defragmented is already highly fragmented, there may be insufficient free space on the hard disk to effectively run a defragmentation process because a complete copy of a defragmented file is made at a new location where the defragmentation process occurs before the original clusters are marked free.

In this case, even if there is a free cluster, it cannot be used for defragmentation.

Defragmentation is the process of storing fragmented files in small clusters that are scattered across a hard disk in continuous clusters. Thus, a hard disk drive (HDD) repeatedly performs a small random read, followed by a small random write.

However, since a typical hard disk exhibits poor small random write/read performance, defragmentation can significantly affect the performance of a host.

Further, data temporarily stored in a DRAM on a host or hard disk needs to be re-read in order to write files in clusters that are scattered over the disk to contiguous clusters. Thus, defragmentation causes frequent I/O actions between the hard disk and the host, thus degrading the performance of the host.

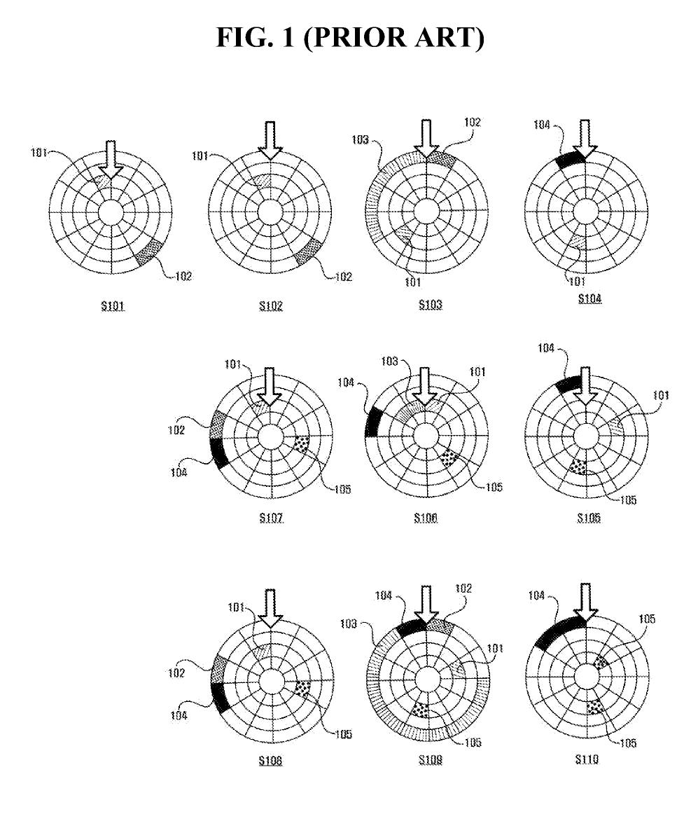

FIG. 1 illustrates a process of defragmenting a file on a typical hard disk.

Referring to FIG. 1, a sector 101 indicated by dashed lines contains a fragmented file that needs to be read during defragmentation. A checkered sector 102 represents a free sector that is prepared for creating contiguous clusters.

A shadowed sector 104 represents a sector in which defragmentation is performed to write data to contiguous clusters. A dotted sector 105 means a sector that has been read during defragmentation and has no meaningful data. That is, the sector 105 is a vacant sector that can be used for another write operation.

A sector 103 indicated by multiple straight lines 103 represents rotational latency for the hard disk.

A defragmentation process executed on the typical hard disk will now be described with reference to FIG. 1. First, data is read from the sector 101 on which fragmentation occurs (S101).

The read data is then stored in DRAM on a host.

After performing step S101, a defrag program seeks the vacant sector 102 that is made available for making contiguous clusters (S102).

The defrag program then moves to the location of the vacant sector 102 and reads data stored in the DRAM to write the data to the vacant sector 102 (S104).

Thereafter, the defrag program seeks a next sector 101 where fragmentation occurs (S105).

The defrag program then moves to the location of the sector 101 (S106) subjected to fragmentation (S106) and reads data from the sector 101 (S107).

In this case, the read data is stored in DRAM.

After performing step S107, the defrag program seeks a vacant sector 102 that is prepared for creating contiguous clusters (S108).

The defrag program then moves to the location of the vacant sector 102 (S109) and reads data stored in the DRAM to write the data to the vacant sector 102 (S110).

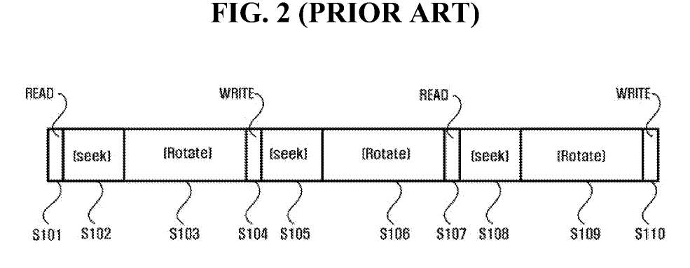

FIG. 2 shows sequential steps in the process illustrated in FIG. 1.

Referring to FIG. 2, the HDD has to expend a large amount of seek time needed to locate a sector where fragmentation occurs or a vacant sector and rotational latency needed to move to the found sector.

During defragmentation, seek time plus rotational latency is longer than the time required to read and/or write data from and/or to the hard disk.

When a hard disk is highly fragmented, defragmentation includes repeating steps S105 through S110, thereby further increasing overhead.

Further, defragmentation causes frequent I/O actions between the host and the DRAM for each read-before-write operation, thus degrading the performance of the host.

The dotted sector 105 that has been read during defragmentation stores meaningless data until defragmentation of files associated with the sector 105 is completed.

That is, the dotted sector 105 cannot be used as a free space, thus resulting in inefficient use of a disk space.

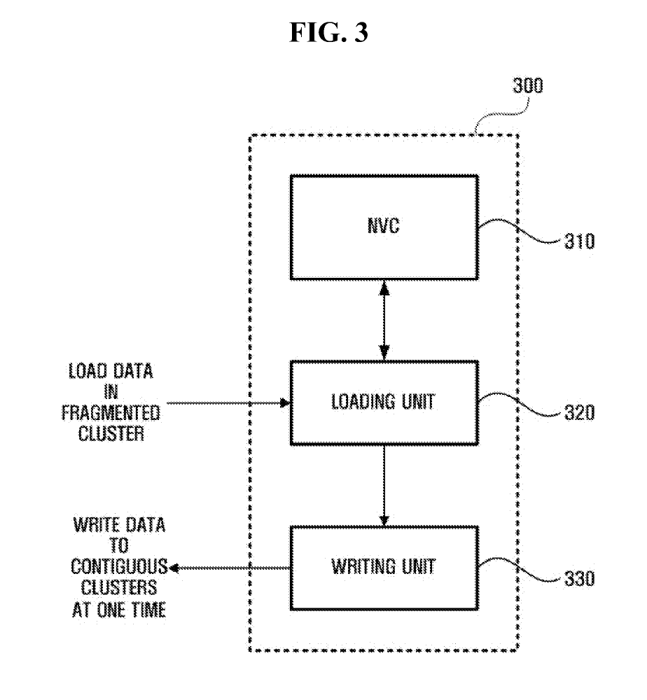

FIG. 3 is a block diagram of an apparatus 300 for defragmenting a file on a hybrid hard disk according to an embodiment of the present invention.

Referring to FIG. 3, the apparatus includes a nonvolatile memory 310 located within the hybrid disk, a loading unit 320 that reads data in a fragmented cluster and temporarily stores the read data in the nonvolatile memory 310, and a writing unit 330 that writes the data temporarily stored in the nonvolatile memory 310 to a contiguous cluster.

Each of various functional components shown in FIG. 3 refers to a software or hardware component, such as a Field Programmable Gate Array (FPGA) or an Application Specific Integrated Circuit (ASIC), which performs certain tasks. However, the functional component may not limited to the software or hardware component and may advantageously be configured to reside on the addressable storage medium and configured to execute on one or more processors.

Thus, the functional component may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

The functionality provided for in the components and modules may be combined into fewer components and modules or further separated into additional components and modules.

The nonvolatile memory 310 is embedded in the hybrid disk, which is also called a NV Cache. In the present embodiment, the nonvolatile memory 310 is hereinafter referred to as “NVC”.

Although a typical hard disk exhibits poor small size random write/read performance, the NVC 310 shows excellent performance in random read/write as well as in consecutive read/write.

The loading unit 320 reads data in a fragmented cluster, temporarily stores the read data in the nonvolatile memory 310, and transfers the stored data to the writing unit 330.

The writing unit 330 writes the data temporarily stored in the NVC 310 to a contiguous cluster at one time.

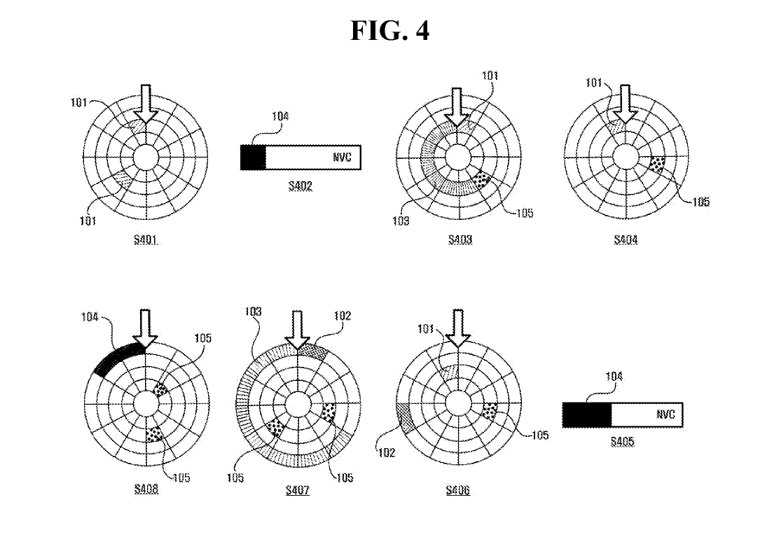

FIG. 4 illustrates a process of defragmenting a file on a hybrid hard disk according to an embodiment of the present invention.

The process of the invention will now be described with reference to FIGS. 3 and 4.

Sectors shown in FIG. 4 have the same reference numerals and meanings as their counterparts in FIG. 1.

First, the loading unit 320 reads data from a sector 101 on which fragmentation occurs (S401) and stores the read data in the NVC 310 (S402).

After performing step S402, the loading unit 320 moves to a next sector 101 on which fragmentation occurs (S403), reads data from the sector 101 (S404), and stores the read data in the NVC 310 (S405) so that it is contiguous with the data stored at step S402.

After storing data for a single file in the NVC 310 by performing steps S401 through S405, the loading unit 320 seeks a vacant sector 102 that is prepared for creating contiguous clusters (S406).

The loading unit 320 then moves to the location of the vacant sector 102 (S407), reads data temporarily stored in the NVC 310, and transfers the read data to the writing unit 330. The writing unit 330 writes the received data to the vacant sector 102 at one time (S408).

If defragmentation is completed by performing the above steps so that all of the fragmented files reside in contiguous clusters, the distance the head moves to access a file can be decreased, thereby improving the performance of the host.

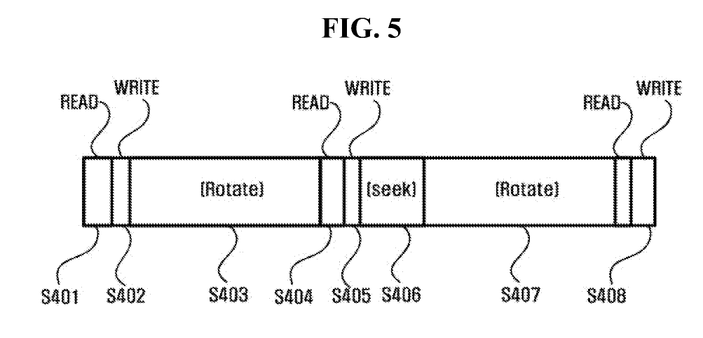

FIG. 5 shows the process illustrated in FIG. 4 over time.

As compared with the process illustrated in FIG. 2, the process of the invention can significantly reduce the seek time and rotational latency that occupy a significant percentage of the total defragmentation time.

If the process illustrated in FIG. 5 is applied to a severely fragmented file, the seek time and rotational latency can be further reduced.

An apparatus and method for defragmenting a file on a hybrid hard disk according to embodiments of the present invention has at least one of the following advantages.

The present invention reduces the number of communications (I/O actions) between the hybrid hard disk and the host, thus preventing degradation in performance of a host due to overload of the disk.

According to the present invention, temporary data generated during defragmentation can be stored in a nonvolatile memory. This reduces the seek time plus rotational latency that is incurred due to movement of a disk arm, thus ensuring long life span and reliability of the disk while reducing the time required for defragmentation.

While the present invention has been particularly shown and described with reference to exemplary embodiments thereof, it will be understood by those of ordinary skill in the art that various changes in form and details may be made therein without departing from the spirit and scope of the present invention as defined by the following claims. Therefore, it is to be understood that the above-described embodiments have been provided only in a descriptive sense and will not be construed as placing any limitation on the scope of the invention.

What is claimed is:

1. A method of defragmenting a file on a hybrid hard disk, comprising:
temporarily storing data of a fragmented cluster in a nonvolatile memory embedded within the hybrid hard disk; and
writing the temporarily stored data to contiguous clusters.

2. The method of claim 1, further comprising reading the data temporarily stored in the nonvolatile memory.

3. The method of claim 1, wherein in the writing of the temporarily stored data to contiguous clusters, the temporarily stored data is written at one time.

4. An apparatus for defragmenting a file on a hybrid hard disk, comprising:
a nonvolatile memory located within the hybrid hard disk;
a loading unit reading data of a fragmented cluster and temporarily storing the read data in the nonvolatile memory; and
a writing unit writing the temporarily stored data in contiguous clusters.

5. The apparatus of claim 4, wherein the loading unit reads the data temporarily stored in the nonvolatile memory and transfers the data to the writing unit.

6. The apparatus of claim 4, wherein the writing unit writes the temporarily stored data at one time.
